(19) United States
(12) Patent Application Publication
(10) Pub. No.: US 2016/0367935 A1
(43) Pub. Date: Dec. 22, 2016

(54) DEFECT-FREE CARBON MOLECULAR SIEVE MEMBRANES WITH ENHANCED SELECTIVITY AND AGING RESISTANCE AND THE METHOD OF MAKING THE SAME

(71) Applicant: L'Air Liquide, Societe Anonyme pour l'Etude et l'Exploitation des Procedes Georges Claude, Paris (FR)

(72) Inventors: Canghai MA, Newark, DE (US); Madhava Kosuri, Newark, DE (US); Tao Li, Garnet Valley, PA (US); Dean Kratzer, Warwick, MD (US); Raja Swaidan, Bear, DE (US)

(21) Appl. No.: 15/253,497

(22) Filed: Aug. 31, 2016

(51) Int. Cl. B01D 53/22; B01D 71/02; B01D 71/70; B01D 67/00; B01D 69/08

(52) U.S. Cl. CPC B01D 53/228; B01D 67/0067; B01D 67/0088; B01D 67/0095; B01D 69/081; B01D 71/70; B01D 71/028; B01D 67/0079; B01D 2325/28; B01D 2053/224; B01D 2325/20

(57) ABSTRACT

A method for making a defect-free carbon molecular sieve (CMS) fiber membrane with an enhanced selectivity and aging resistance includes the steps of fabricating the CMS fiber membrane by pyrolyzing a polymer precursor, coating a thin layer of the silicone rubber on the CMS fiber membrane with the silicone rubber solution and drying the coated CMS fiber membrane to remove the organic solvent. The silicone rubber may be a poly(siloxane) containing repeating units of the moiety of the following formula:

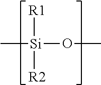

wherein R₁ and R₂ each is independently selected from the group consisting of an H, a C₁-C₂₀ aliphatic group, a C₃-C₂₀ aromatic group, and a C₁-C₈ saturated or unsaturated alkoxy group. The silicone rubber may be PDMS.

### TECHNICAL FIELD

The present invention relates to defect-free carbon molecular sieve (CMS) membranes and methods for repairing CMS membrane defects, enhancing selectivity and stabilizing the CMS membranes against aging.

### BACKGROUND

Gas separation membranes of selectively gas permeable materials are well known and commercially important devices for separating the components of gas mixtures in many industries. These membranes have many physical forms such as plate-and-frame, spiral-wound and hollow fiber modules. Membranes in the form of small diameter hollow fibers are particularly valued mainly because they can be assembled in bundles within modules that provide very high gas transfer surface area within extraordinarily small module volume.

Carbon molecular sieves (CMS) membranes have been considered as one the most promising membranes due to their superior gas separation performance. However, CMS membranes experience drastic permeance loss during their early stages due to the physical aging of membranes and sorption induced aging. The physical aging refers to the process through which the membrane densifies towards a more equilibrium state. The sorption induced aging refers to the permeance loss caused by species sorbed in the membranes, such as moisture, oxygen, hydrocarbon contaminants etc. Protective gases, such as N₂, are used to store CMS membranes to reduce the aging of CMS membranes, which, however, are problematic since the membranes need to contact with the protective gases once produced. A method to mitigate CMS membrane loss during aging without using protective gas is crucial to develop commercially viable CMS membrane products.

U.S. Pat. No. 4,654,055 to Malon et al. discloses the usage of silicone rubber as a coating layer to caulk defects of polymeric membranes with good compatibility of polymer membrane and coating polymer. Saufi et al. (S. M. Saufi, A. F. Ismail, Fabrication of CMS membranes for gas separation—a review, Carbon, 42 (2004), pp 241-259) disclosed using silicone rubber coating in repairing the carbon dense film membrane defects. However, the degree of selectivity improvement was not reported. To date, the silicone rubber post-treatment has not been applied in the CMS membrane fibers. The long-term effects of the silicone rubber post-treatment have not been analyzed.

### SUMMARY

There is disclosed a method for making a defect-free carbon molecular sieve (CMS) hollow fiber membrane with an enhanced selectivity and aging resistance that comprises the steps of fabricating the CMS fiber membrane by pyrolyzing a polymer precursor fiber membrane, dissolving a silicone rubber in an organic solvent to form a silicone rubber solution, coating a layer of the silicone rubber on the CMS fiber membrane with the silicone rubber solution, and drying the coated CMS fiber membrane to remove the organic solvent, wherein the silicone rubber is a poly(siloxane) containing repeating units of the moiety of formula:

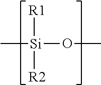

wherein R₁ and R₂ each is independently selected from the group consisting of an H, a C₁-C₂₀ aliphatic group, a C₃-C₂₀ aromatic group, and a C₁-C₈ saturated or unsaturated alkoxy group.

There is also disclosed the coating step is done by soaking the CMS fiber membrane in the silicon rubber solution.

There is also disclosed a defect-free CMS membrane made of the polymer precursors.

There is also disclosed a defect-free CMS membrane module including a plurality of the above-disclosed defect-free CMS membrane.

There is also disclosed a defect-free CMS membrane made of coating a silicone rubber layer on the skin layer of the CMS membrane to form a composite of the CMS membrane that not only repairs defects of CMS membranes but also significantly reduces physical aging and sorption induced aging of CMS membranes simultaneously.

There is also disclosed the silicone rubber is poly(siloxane).

There is also disclosed the poly(siloxane) is poly(dimethylsiloxane) (PDMS).

Any of the methods, the resultant CMS membrane, the defect-free CMS membrane, the CMS membrane, the CMS fiber membrane, the CMS membrane module or the defect-free CMS membrane module may include one or more of the following aspects:
a monolithic hollow fiber;
a composite hollow fiber having a sheath layer surrounding a core layer;
the polymer precursor being made of a polymer or copolymer selected from the group consisting of polyimides, polyetherimides, polyamide-imides, cellulose acetate, polyphenylene oxide, polyacrylonitrile, and combinations of two or more thereof;
the polymer precursor being made of polyimide;
the polyimide being made of the repeating units of formula I:

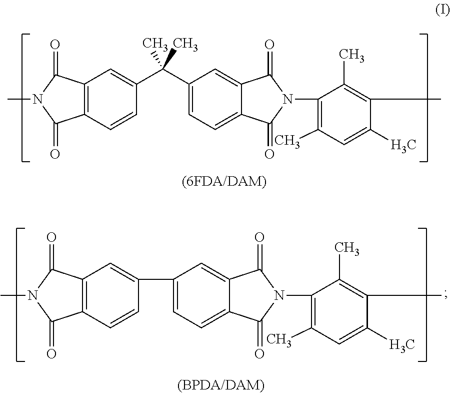

the polyimide being 6FDA/BPDA-DAM;
the polyimide being 6FDA-mPDA/DABA;
the polyimide being 6FDA-DETDA/DABA;
the polyimide being Matrimid having the repeating units of formula II:

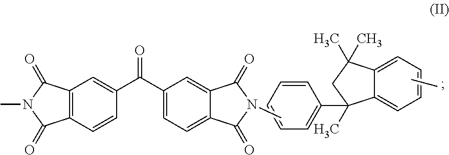

the polyimde being Kapton being poly (4,4′-oxydiphenylene-pyromellitimide);
the polyimde being P84 consisting of the repeating units of formula III:

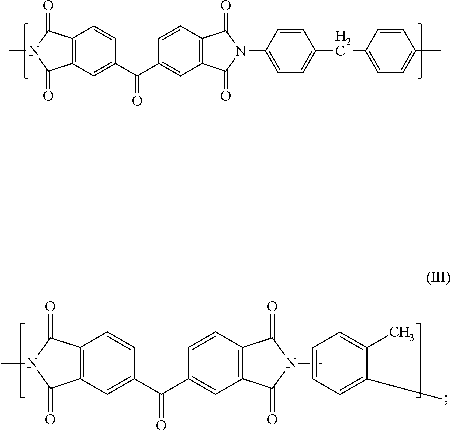

the polymer precursor being made of polyether imide;
the polyetherimide including Ultem having the repeating units of formula IV:

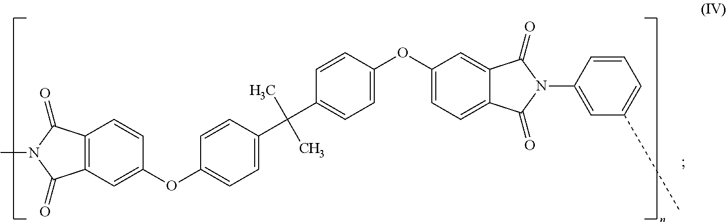

the polymer fiber material being made of polyamide imide;
the polyamide-imide including Torlon having the repeating units of formulae V and VI:

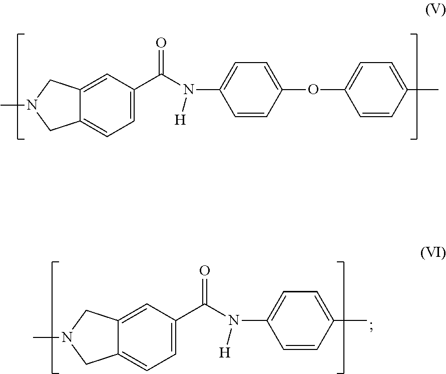

the silicone rubber being a poly(siloxane) containing repeating units of the moiety of formula:

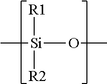

wherein R₁ and R₂ each is independently selected from the group consisting of a H, a C₁-C₂₀ aliphatic group, a C₃-C₂₀ aromatic group, and a C₁-C₈ saturated or unsaturated alkoxy group;
the poly(siloxanes) being poly(dimethylsiloxane) (PDMS);
the silicone rubber solution being 0.1-20% silicone rubber in an organic solvent;
the silicone rubber solution being 0.1-10% silicone rubber in an organic solvent;
the silicone rubber solution being 0.1-5% silicone rubber in an organic solvent;
the silicone rubber solution being 0.1-20% silicone rubber in iso-octane;
the silicone rubber solution being 0.1-10% silicone rubber in iso-octane;
the silicone rubber solution being 0.1-5% silicone rubber in iso-octane;
the silicone rubber solution being 0.1-20% silicone rubber in pentane;
the silicone rubber solution being 0.1-10% silicone rubber in pentane;
the silicone rubber solution being 0.1-5% silicone rubber in pentane;
the soaking time for the soaking step being 1-120 min;
the soaking time for the soaking step being 2 min;
the temperature for the coating step being ambient temperature;
the temperature for the coating step being a temperature below a flash point of the solvent;
the PDMS solution being 0.1-20% PDMS in an organic solvent;
the PDMS solution being 0.1-10% PDMS in an organic solvent;
the PDMS solution being 0.1-5% PDMS in an organic solvent;
the PDMS solution being 0.1-20% PDMS in iso-octane;
the PDMS solution being 0.1-10% PDMS in iso-octane;
the PDMS solution being 0.1-5% PDMS in iso-octane;
the PDMS solution being 0.1-20% PDMS in pentane;
the PDMS solution being 0.1-10% PDMS in pentane;
the PDMS solution being 0.1-5% PDMS in pentane.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a block diagram of a hollow fiber membrane structure;

FIG. 2 is a block diagram showing “Pin-hole” defects in a CMS membrane skin layer;

FIG. 3 is a block diagram for “Pin-hole” defects caulked with PDMS in the CMS membrane skin layer;

FIG. 4 is a block diagram of the reduced aging of CMS by using coating silicone layer.

FIG. 5 is a graph of CO₂ permeance of CMS membrane modules with and without PDMS coating treatment under different process conditions over time in logarithm; and

FIG. 6 is a graph of CO₂/CH₄ selectivity changes of CMS membrane modules with and without PDMS coating treatment under different process conditions over time in logarithm.

### DESCRIPTION OF PREFERRED EMBODIMENTS

Disclosed are defect-free CMS membranes with enhanced selectivity and aging resistance and methods for repairing CMS membrane defects, enhancing selectivity and stabilizing CMS membranes against aging by using a silicone rubber coating technique.

The disclosed defect-free CMS membranes are made of coating a silicone rubber layer on the skin layer of the CMS membrane to form a coating layer on the CMS membrane that not only repairs defects of CMS membranes but also significantly reduces physical aging and sorption induced aging of CMS membranes simultaneously.

The disclosed CMS membranes are fabricated by pyrolyzing polymer precursors. The pyrolyzing process includes heating the polymer precursor in a furnace at least at a temperature ranging from 500° C. to 800° C. for a period of time, for example, 2 hours, at which pyrolysis byproducts are evolved, and an inert gas is flowing through the furnace. The inert gas may be N₂, He, Ar, or the like, and may or may not contain less than 150 ppm of oxygen. After potting the CMS membranes into a module, the membrane module is further coated with a silicone layer to repair any “pin-hole” skin defects and enhance the resistance of physical aging and chemisorption induced aging.

The most widely used model to describe the process of the CMS membranes for separating gas pair is the diffusion-solution mechanism. In this model, gas molecules of the gas pair first sorb on the upstream of the CMS membrane, then diffuse through the membrane due to gas concentration gradients in the membrane. Finally, the gas molecules desorb in the downstream of the membrane. In this way, gas mixtures are separated due to their different solubilities in the membrane and diffusivities through the membrane.

Gas permeability and selectivity are two commonly used parameters in defining the gas separation performance of CMS membranes. The permeability, P, is determined by the product of the diffusion coefficient, D, and sorption coefficient, S, having the following relationship:

P=D*S

The selectivity, α_{A/B}, is defined by the ratio of gas permeability in the membrane for a gas pair, A and B, having the following relationship:

α_{A/B}=P_{A}/P_{B}

Gas permeance is often used instead of permeability to describe the gas permeation flux of a hollow fiber membrane. The permeance is defined by the permeability divided by the effective separation layer thickness (l) with the unit of gas permeation unit (GPU).

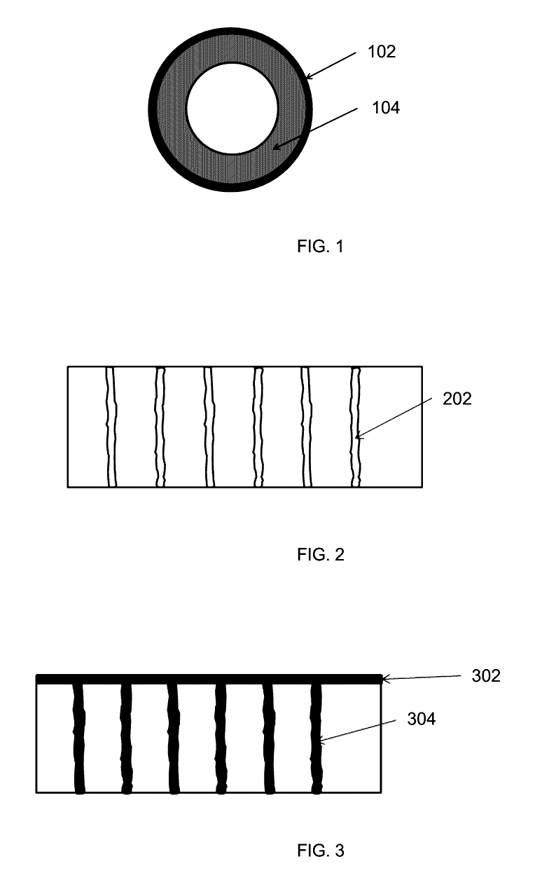

The hollow fiber membrane has an extremely thin skin layer to separate gas mixtures. Underneath the skin of hollow fiber are the transition layer and porous layer to provide mechanical strength, as show in FIG. 1. FIG. 1 is a block diagram of a hollow fiber membrane structure. As illustrated, 102 is a skin layer of the membrane and 104 is a porous supporting layer of the membrane.

Ideally, skin layer 102 is defect-free, which is integral and free of “pin-hole” defects. However, due to any variables of material synthesis, membrane formation process etc, the membrane may have a defective skin, which means an extremely high gas permeation flux with low selectivity. It is believed that defective CMS membranes have minor “pin-hole” defects in the selective skin layer, indicated by the microporous or ultramicroporous diffusion paths for gas molecules in FIG. 2. FIG. 2 is a block diagram showing “pin-hole” defects in a CMS membrane skin layer. As shown, 202 are “pin-hole” defects showing as defective channels. Such defective channels allow a very high gas diffusion flow for the penetrant mixtures that need to be separated, which, however, do not selectively remove one species over another. The lower selectivity is undesirable as it increases the cost of separation; in the worst case, it does not separate the gas pair at all.

To prepare desirable high performance gas separation membranes, the skin defects need to be repaired to increase the selectivity without prohibitively losing gas permeance. Without being bonded with any particular theories, it is believed that the silicone-containing material may penetrate into the pin-hole defects of the CMS membrane skin layer and caulk the defects by blocking the “defective” channels of the membranes, as shown in FIG. 3. FIG. 3 is a block diagram for “pin-hole” defects caulked with PDMS in the CMS membrane skin layer. As illustrated, 302 is a silicone layer and 304 is “pin-hole” caulked by silicone. The defects in the skin layer of CMS membranes are repaired by the silicone materials. As the non-selective diffusion channels (the “pin-hole” defects) are blocked by the silicone material, the gas molecules do not diffuse through those paths as easily as in the case of defective membranes and are forced to diffuse through the selective channels. As a result, the gas separation selectivity is greatly enhanced. On the other hand, the additional silicone layer on the skin surface reduces the gas permeance due to added gas transport resistance. However, the silicone layer is typically very thin and gas permeable, thus, the gas permeance of caulked membrane is not significantly compromised. By repairing the “pin-hole” defects, the CMS membrane can achieve both very high selectivity and gas permeance.

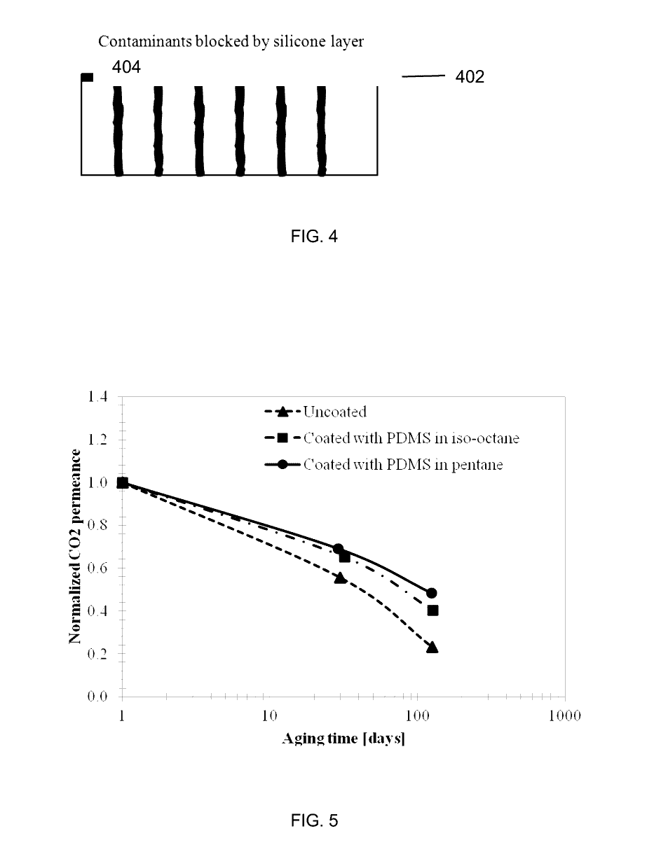

Despite the superior separation performance, the CMS membrane suffers from significant gas permeance loss over time, which reduces the gas separation productivity. The time induced permeance loss is believed to be caused by the physical aging and sorption induced aging. The sorption induced aging may refer to gas permeance loss caused by any species that are sorbed in the CMS membrane pores. The species may be moisture, oxygen, hydrocarbons, aromatics etc that may be bonded with the CMS material. As a result, the sorption induced aging reduces the pore sizes of CMS membrane and thereby reduces the gas permeance. FIG. 4 is a block diagram of the reduced aging of CMS by using coating silicone layer. As shown by FIG. 4, thin silicone layer 402 is believed to serve as a barrier layer to stop the invasion of contamination chemicals 404 to the CMS membrane matrix, especially for heavy hydrocarbon containments. Therefore, the silicone layer may mitigate the sorption induced aging of CMS membranes.

Depending on the form of the polymer precursors, the disclosed CMS membranes may be in a hollow fiber form having an inner diameter (ID) ranging from 50 to 400 μm and an outer diameter (OD) ranging from 100 to 500 μm, but not limited to, if a polymer precursor fiber is pyrolyzed.

The disclosed CMS membrane fiber may be a monolithic hollow fiber or a composite hollow fiber. The monolithic CMS membrane hollow fiber is made of one polymer precursor. The composite CMS membrane hollow fiber has a polymeric sheath layer comprising a first polymer precursor and a polymeric core layer adjacent to and radially inward the sheath layer comprising a second polymer precursor. The first and the second polymer precursors may be the same polymer precursors or different polymer precursors.

The polymer precursors, including the first and second polymer precursors for the composite CMS membrane fibers, may be any polymer or copolymer known in the field of polymeric membranes for fluid (i.e., gases, vapors and/or liquids) separation. Typical polymers suitable for the CMS membranes may be substituted or unsubstituted polymers and includes, but is not limited to, polyimides, polyetherimides, polyamide-imides, cellulose acetate, polyphenylene oxide, polyacrylonitrile, and combinations of two or more thereof.

Exemplary suitable polyimides include 6FDA/BPDA-DAM, 6FDA-mPDA/DABA, 6FDA-DETDA/DABA, Matrimid, Kapton, and P84.

6FDA/BPDA-DAM, shown below, is a polyimide synthesized by imidization from three monomers: 2,4,6-trimethyl-1,3-phenylene diamine (DAM), 2,2′-bis(3,4-dicarboxyphenyl hexafluoropropane) (6FDA), and 3,3′,4,4′-biphenyl tetracarboxylic acid dianhydride (BPDA). 6FDA/BPDA-DAM is a polyimide made up repeating units of 6FDA/DAM and BPDA/DAM in formula I:

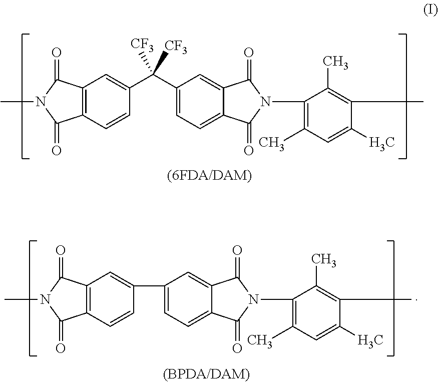

6FDA-mPDA/DABA is a polyimide synthesized by imidization from three monomers: 2,2′-bis(3,4-dicarboxyphenyl hexafluoropropane) (6FDA), 1,3-phenylenediamine (mPDA), and 3,5-diaminobenzoic acid (DABA).

6FDA-DETDA/DABA is a polyimide synthesized by imidization from three monomers: 2,2′-bis(3,4-dicarboxyphenyl hexafluoropropane) (6FDA), 2,5-diethyl-6-methyl-1,3-diamino benzene (DETDA), and 3,5-diaminobenzoic acid (DABA).

Matrimid has the repeating units of formula II:

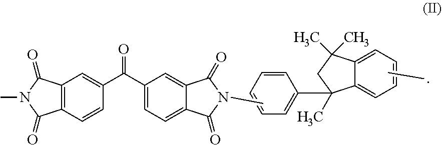

Kapton is poly (4,4′-oxydiphenylene-pyromellitimide).

P84 consists of repeating units of formula III:

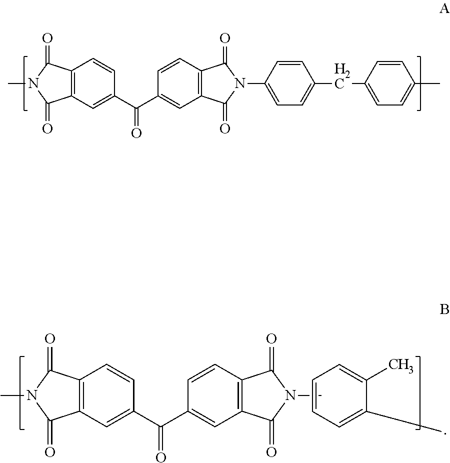

A suitable polyetherimide includes Ultem having the repeating units of formula IV:

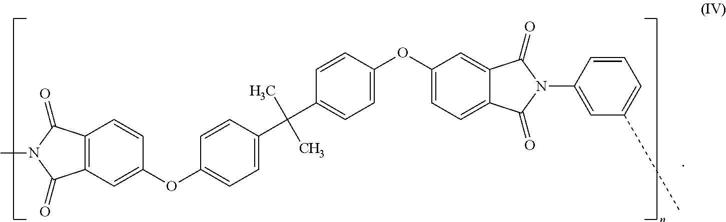

A suitable polyamide-imide includes Torlon having the repeating units of formulae V and VI:

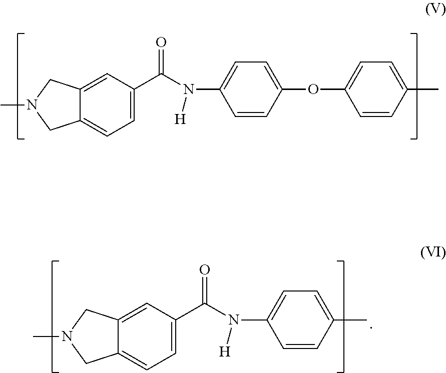

In the disclosed method, the CMS fiber membranes are fabricated by the above disclosed pyrolyzing polymer fiber precursors. A CMS membrane module is then formed with a bundle of CMS fiber membranes. The bundle of CMS fiber membrane may contain hundreds or thousands of CMS fibers. After the CMS membrane module is formed, optionally, the CMS membrane module may be characterized with a mixed gas permeation before further treatments, which provides the mixed gas permeation properties of the CMS membrane module without further treatments.

In the disclosed method, after forming the CMS membrane module, the next step is to coat a thin layer of a silicone rubber on the CMS membrane modules with a solution of the silicone rubber. The concentration of the silicone rubber solution may preferably be 0.1-20% silicone rubber in iso-octane or pentane or other suitable organic solvent. The concentration of the silicone rubber solution may more preferably be 0.1-10% silicone rubber in iso-octane or pentane or other suitable organic solvent. The concentration of the silicone rubber solution may even more preferably be 0.1-5% silicone rubber in iso-octane or pentane or other suitable organic solvent. The CMS membrane module includes two shell side openings perpendicular to the length of the CMS fibers and two bore side openings located at the two ends of the CMS fibers. The coating may be performed by pouring or dropping the silicone rubber solution into the shell side opening of the CMS membrane module and have the silicone rubber solution soak the CMS membrane module for a few minutes to form a coating layer on the CMS membrane surface. The soaking time or dipping time may be from several minutes to several hours, for example, from 1 min to 2 hours. The preferred soaking time or dipping time is 2 mins. The temperature for coating the silicone rubber may be ambient or room temperature, or a temperature below the flash point of the solvent. After soaking or dipping, the coated CMS membrane module is dried in order to remove the solvent. Air and inert gases, such as N₂, may be used first to purge the shell side of module to remove bulk solvent in the CMS membrane. Then the membrane module may be heated to a temperature up to 200° C. in a vacuum oven to further remove the residual solvent in the CMS membrane.

The silicone rubber for coatings may be poly(siloxane) containing repeating units of the moiety of formula:

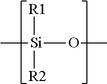

wherein R₁ and R₂ each is independently selected from the group consisting of an H, a C₁-C₂₀ aliphatic group, a C₃-C₂₀ aromatic group, and a C₁-C₈ saturated or unsaturated alkoxy group. Common aliphatic and aromatic poly(siloxanes) include the poly(monosubstituted and disubstituted siloxanes), e.g., wherein the substituents are lower aliphatic, for instance, lower alkyl, including cycloalkyl, especially methyl, ethyl, and propyl, lower alkoxy; aryl including mono or bicyclic aryl including bis phenylene, naphthalene, etc.; lower mono and bicyclic aryloxy; acyl including lower aliphatic and lower aromatic acyl; and the like. The aliphatic and aromatic substituents may be substituted, e.g., with halogens, e.g., fluorine, chlorine and bromine, hydroxyl groups, lower alkyl groups, lower alkoxy groups, lower acyl groups and the like.

Preferably, the poly(siloxanes) is poly(dimethylsiloxane) (PDMS), when R₁ and R₂ are —CH₃ in the formula (I). Herein, if PDMS is used, the PDMS solution may preferably be 0.1-20% PDMS in iso-octane or pentane or other suitable organic solvent; or more preferably 0.1-10%; or even more preferably 0.1-5%.

After forming the CMS membrane modules with PDMS coating, the resultant CMS membrane modules may periodically be tested with mixed gases, for example, CO₂/CH₄, at a pressure ranging from 100 to 800 psig over a period of time. The period of time for the aging tests may be at least one month; preferably 3 months; more preferably 6 months; even more preferably 12 months or two years or more. Herein, between each test, the CMS membrane modules may be stored in a sealed bag with ambient air in the presence of both physical aging and sorption induced aging. In order to demonstrate the effects of the coating treatment on the CMS membrane modules, another set of CMS membrane modules without silicone rubber coating may also be tested and compared with the CMS membrane modules that have silicone rubber coating.

The disclosed method may be suitable for any gas separation membranes. For example, polymeric membranes.

### EXAMPLES

The following non-limiting example is provided to further illustrate embodiments of the invention. However, the example is not intended to be all inclusive and are not intended to limit the scope of the inventions described herein.

Example: CMS membrane fibers were fabricated by pyrolyzing 6FDA/BPDA-DAM polymer precursors at 550° C. for 2 hrs under Argon purge with 30 ppm O₂. CMS membrane modules were formed from a bundle of CMS fibers. After the modules were formed, the modules were characterized with mixed gas permeation in order to obtain the permeation properties of the CMS membrane modules. Then the modules were post-treated by coating a PDMS thin layer using 0.5% PDMS in iso-octane and 0.5% PDMS in pentane. The PDMS solution was poured into the module through the shell side opening of the CMS membrane module and soaked the CMS membrane module for about 2 mins to form a PDMS coating layer on the CMS membrane surface.

In the following step, the resultant PDMS coated CMS membrane modules were periodically tested with mixed gases of 10/90 CO₂/CH₄ at 200 psig from a period of over 120 days. Between each test, the fiber samples were stored in a sealed bag with ambient air in the presence of both physical aging and sorption induced aging. In order to demonstrate the effects of coating treatment on the CMS membrane modules, another set of CMS membrane modules without PDMS coating treatment were also tested and compared with those having PDMS coating treatment.

FIG. 5 is a graph of CO₂ permeance of CMS membrane modules with and without PDMS coating treatment under different process conditions over time in logarithm. The aging tests were done with 10/90 CO₂/CH₄ mixed gas at 200 psig at 22° C. The normalized CO₂ permeance is defined by the ratio of the permeance at different aging time to the initial permeance. As illustrated in FIG. 5, the aging behaviors between the CMS membrane modules with and without the PDMS coating treatment are different. The results of the CMS membrane module with PDMS coating treatment show a CO₂ permeance loss of 50-60% after aging about 120 days. However, the results of the CMS membrane modules without PDMS coating treatment show a permeance reduction of ˜80% during the same aging time. This suggests that the aging may be effectively mitigated by the PDMS coating treatment and the CMS membrane modules are expected to maintain a high flux of the gases to be separated for an extended period of time.

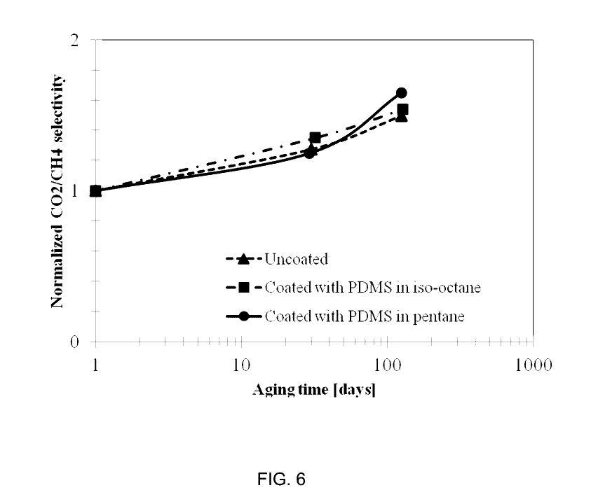

FIG. 6 is a graph of CO₂/CH₄ selectivity changes of CMS membrane modules with and without PDMS coating treatment under different process conditions versus log(time). The aging tests were done with 10/90 CO₂/CH₄ mixed gas at 200 psig at 22° C. Similarly, the normalized CO₂/CH₄ selectivity is defined by the ratio of the selectivity at different aging time to the initial selectivity. As shown in FIG. 6, the CO₂/CH₄ selectivity of the CMS membrane modules is increased in both the CMS membrane modules with and without the PDMS treatments over time in logarithm, following the typical aging trend of a membrane.

Returning to the resultant PDMS coated CMS membrane modules, it is believed that the PDMS coating repaired the CMS membrane defects. The permeation and selectivity results before and after PDMS coatings on the CMS membrane modules are summarized in Table 1.

TABLE 1
Results of before and after PDMS coating

| CMS membrane module | CO₂ permeance/GPU | CO₂/CH₄ selectivity |
|---|---|---|
| Before PDMS coating | 658 ± 72 | 34 ± 5 |
| After PDMS coating | 218 ± 7 | 68 ± 11 |
| Changes % | 67%↓ | 100%↑ |

As shown in Table 1, the CMS membrane before PDMS coating had an extremely high CO₂ permeance with a moderate CO₂/CH₄ selectivity. However, the selectivity of CO₂/CH₄ was doubled after PDMS coating, approaching the intrinsic CO₂/CH₄ selectivity of CMS membranes. This demonstrates that the CMS membranes after PDMS coating were defect-free with excellent gas separation efficiency. On the other hand, the permeance of the CMS membrane module was reduced by 67% after PDMS coating due to the additional mass transfer resistance of the PDMS layer. However, the CO₂ permeance upon coating was still quite attractive and the separation productivity of coated CMS membranes was desirable. The results shown in Table 1 suggest that the PDMS coating treatment is an effective approach to caulk the defects of CMS membrane hollow fibers without prohibitively reducing the separation fluxes.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“About” or “around” or “approximately” in the text or in a claim means ±10% of the value stated.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A method for making a defect-free carbon molecular sieve (CMS) fiber membrane with an enhanced selectivity and aging resistance, the method comprising the steps of:
fabricating the CMS fiber membrane by pyrolyzing a polymer precursor fiber membrane;
dissolving a silicone rubber in an organic solvent to form a silicone rubber solution;
coating a layer of the silicone rubber on the CMS fiber membrane with the silicone rubber solution; and
drying the coated CMS fiber membrane to remove the organic solvent,
wherein the silicone rubber is a poly(siloxane) containing repeating units of the moiety of the following formula: 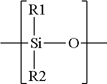
wherein R₁ and R₂ each is independently selected from the group consisting of an H, a C₁-C₂₀ aliphatic group, a C₃-C₂₀ aromatic group, and a C₁-C₈ saturated or unsaturated alkoxy group.

2. The method of claim 1, wherein the silicone rubber solution is a 0.1-20% silicone rubber in the organic solvent.

3. The method of claim 1, wherein the organic solvent is iso-octane or pentane or other organic solvent.

4. The method of claim 1, wherein the coating step is done by soaking the CMS fiber membrane in the silicon rubber solution.

5. The method of claim 4, wherein a soaking time for the soaking step is 1-120 min.

6. The method of claim 4, wherein a soaking time for the soaking step is 2 min.

7. The method of claim 1, wherein the coating step is done at room temperature.

8. The method of claim 1, wherein the drying step is done at room temperature.

9. The method of claim 1, wherein R₁ and R₂ are —CH₃, and the poly(siloxane) is poly(dimethylsiloxane) (PDMS).

10. The method of claim 1, wherein the silicone rubber solution comprises 0.1-20% PDMS in iso-octane or pentane or other organic solvent.

11. The method of claim 1, wherein the silicone rubber solution comprises 0.1-20% PDMS in iso-octane or pentane or other organic solvent.

12. The method of claim 1, wherein the silicone rubber solution comprises 0.1-5% PDMS in iso-octane or pentane or other organic solvent.

13. The method of claim 1, wherein the polymer precursor is selected from the group consisting of polyimides, polyetherimides, polyamide-imides, cellulose acetate, polyphenylene oxide, polyacrylonitrile, and combinations of two or more thereof.

14. The method of claim 13, wherein the polyimide is selected from the group consisting of 6FDA/BPDA-DAM, 6FDA-mPDA/DABA, 6FDA-DETDA/DABA, Matrimid having the repeating units of the following formula: 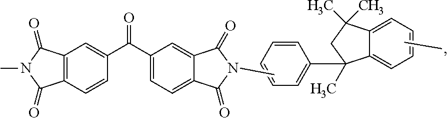
Kapton being poly (4,4′-oxydiphenylene-pyromellitimide), and P84 consisting of the repeating units of the following formulae:

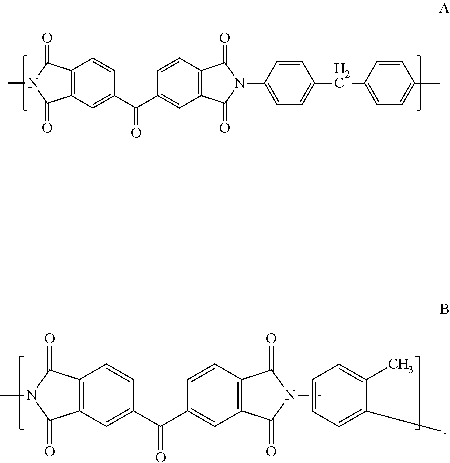

15. The method of claim 14, wherein 6FDA/BPDA-DAM is made of the repeating units of the following formula:

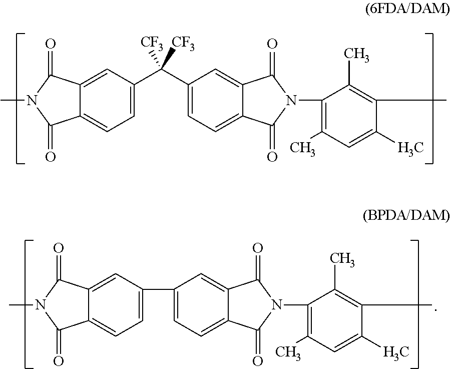

16. The method of claim 13, wherein the polymer precursor is made of polyetherimide including Ultem having the repeating units of the following formula: 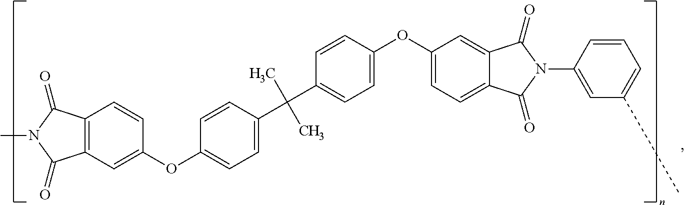
or made of polyamide-imide including Torlon having the repeating units of the following formulae:

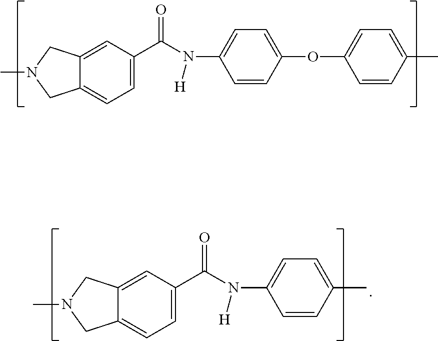

17. A defect-free CMS hollow fiber membrane with an enhanced selectivity and aging resistance produced according to the method of claim 1.

18. A defect-free CMS membrane module with an enhanced selectivity and aging resistance including a plurality of the defect-free CMS hollow fiber membrane of claim 17.

19. The defect-free CMS hollow fiber membrane of claim 17, wherein the silicone rubber is PDMS.
